(19) United States
(12) Patent Application Publication
(10) Pub. No.: US 2017/0207639 A1
(43) Pub. Date: Jul. 20, 2017

(54) VIRTUAL BATTERY COMPRISING INDIVIDUALLY MANAGED ENERGY STORAGE UNITS

(71) Applicant: Ranch Systems LLC, Novato, CA (US)

(72) Inventor: Jacob Christen Christfort, Novato, CA (US)

(21) Appl. No.: 15/405,564

(22) Filed: Jan. 13, 2017

Related U.S. Application Data
(60) Provisional application No. 62/279,399, filed on Jan. 15, 2016.

(51) Int. Cl. H02J 7/00

(52) U.S. Cl. CPC H02J 7/0021; H02J 7/0003; H02J 7/007

(57) ABSTRACT

Herein are smart systems for combining disparate energy storage systems into a single virtual re-chargeable battery. In an embodiment, a virtual battery system contains a cluster of energy storage units, controllers, storage media, and one or more processors. Each controller is configured to monitor and control a respective energy storage unit in the cluster of energy storage units. Stored in the storage media are one or more programs configured for execution by the processors. The programs have instructions whose execution causes collecting, from the controllers, performance data for each energy storage unit in the cluster of energy storage units. Execution of the instructions also cause, based on the performance data, individually adjusting a charging or a discharging of one or more energy storage units in the cluster of energy storage units.

### CROSS-REFERENCE TO RELATED APPLICATIONS; BENEFIT CLAIM

This application claims the benefit of Provisional Appin. 62/279,399, filed Jan. 15, 2016, the entire contents of which is hereby incorporated by reference for all purposes as if fully set forth herein. The applicant(s) hereby rescind any disclaimer of claim scope in the parent application or the prosecution history thereof and advise the USPTO that the claims in this application may be broader than any claim in the parent application.

### TECHNICAL FIELD

The present disclosure relates to the technical field of energy storage. More specifically, the example embodiment(s) of the present disclosure relate to a virtual battery comprising individually managed energy storage units.

### BACKGROUND

Efficient storage of electrical energy is of increasing importance, especially since the growth of solar and wind energy which all create electrical energy intermittently. In many cases, the energy is not needed on the electrical grid at the time of generation. Therefore, the efficient storage of electrical energy is increasingly valuable. As a result, new types of electrical energy storage are being developed and more will be developed in future. Examples include various types of batteries (e.g., NiCd, NiMH, SLA, Li-Ion) as well as types of storage for mechanical (e.g., Flywheel, compressed gas) or chemical (e.g., power to gas) energy.

However, each type of storage (e.g., a different type of battery) typically has unique requirements regarding how to efficiently charge it (e.g., store energy in the storage) as well as limitations on how to load it (e.g., retrieve energy from the storage). For example, a solar or wind system typically needs a multitude of different charge/load controllers that are built-in. Thus, older systems may not be able to take advantage of newer energy storage systems as they emerge.

Another problem is that different storage system units typically cannot be combined to increase capacity. In other words, creating clusters of storage system units typically involves the precondition of certain similarities between/among the storage system units. For example, batteries can typically be efficiently combined if of the same chemistry, voltage, capacity, and age. In fact, a weak battery will often degrade the performance of all other batteries in a typical cluster of parallel batteries. Furthermore, batteries in a cluster typically cannot be in different stages. In other words, some batteries cannot be charging while others are powering a load. Still further, each battery in a cluster cannot be monitored and exchanged individually without taking the cluster “offline”. This creates a problem as systems naturally need to expand over time.

The aforementioned problems can also contribute to a substantial environmental problem. Old solar/wind controllers may need to be discarded to take advantage of new energy storage systems, and old energy storage units (e.g., batteries) may be prematurely discarded due to mismatch.

### BRIEF DESCRIPTION OF THE DRAWINGS

In the drawings:

FIG. 1 is a block diagram that depicts an example virtual battery cluster, in an embodiment;

FIG. 2 is a block diagram that depicts an example virtual battery controller, in an embodiment;

FIG. 3 is a block diagram that illustrates a computer system upon which an embodiment of the invention may be implemented.

### DETAILED DESCRIPTION

The present disclosure is related to a Virtual Battery Comprising Individually Managed Energy Storage Units.

General Overview

The present disclosure proposes a smart system for combining disparate energy storage systems into a single virtual rechargeable battery. Specifically:
1) Different storage units are charged from a single backplane such that each storage unit is subject to an optimal charge process. From the perspective of the charge controller delivering the energy, however, the charge curve looks like that of a traditional battery (of freely configurable type).
2) Different storage units are controlled such that they deliver energy back to connected loads in a manner similar to that of a traditional battery (of freely configurable type).

In an embodiment, a virtual battery system contains a cluster of energy storage units, controllers, storage media, and one or more processors. Each controller is configured to monitor and control a respective energy storage unit in the cluster of energy storage units. Stored in the storage media are one or more programs configured for execution by the processors. The programs have instructions whose execution causes collecting, from the controllers, performance data for each energy storage unit in the cluster of energy storage units. Execution of the instructions also cause, based on the performance data, individually adjusting a charging or a discharging of one or more energy storage units in the cluster of energy storage units.

Virtual Battery

A virtual battery can be created by combining—or clustering—a multitude of disparate energy storage systems (e.g., energy storage units) in such a way that the virtual battery is indistinguishable from a traditional rechargeable battery. An extreme example would be combining N1 batteries, N2 flywheels, and N3 super-capacitors into one virtual battery. A more typical example would be to combine a multitude of batteries of various chemistries and sizes into one efficient virtual battery. The following description assumes a virtual battery comprising heterogeneous batteries, but by replacing battery controller with, for example, flywheel controllers, a more general invention can be realized.

The virtual battery is created by means of a cluster controller or set of communicating cluster controllers that each control a number of potentially heterogeneous batteries (or energy storage units) such that they appear to attached charge sources and loads as a single, virtual rechargeable battery. The batteries in the cluster can be of different voltages, types, and/or chemistries, such as NiCd, Sealed Lead Acid, or Li-Ion. They can also be at various stages of age and capacity. The controller(s) can auto-detect or be explicitly configured with the type of each battery.

Irrespective of the batteries in the cluster, the type of the virtual battery presented to outside loads and charge sources can be configured independently. For example the virtual battery may be configured as a virtual NiMh battery even though the actual batteries in the cluster are Sealed Lead Acid. This enables the use of existing charge sources that expect a certain type of battery.

One controller can control one cluster of batteries forming one virtual battery, but multiple controllers can be connected in series or parallel and collaborate via a digital communication bus to form even larger, composite virtual batteries. In that case, we can refer to each primary cluster as a sub-cluster in a hierarchy of clusters.

Cluster Controller

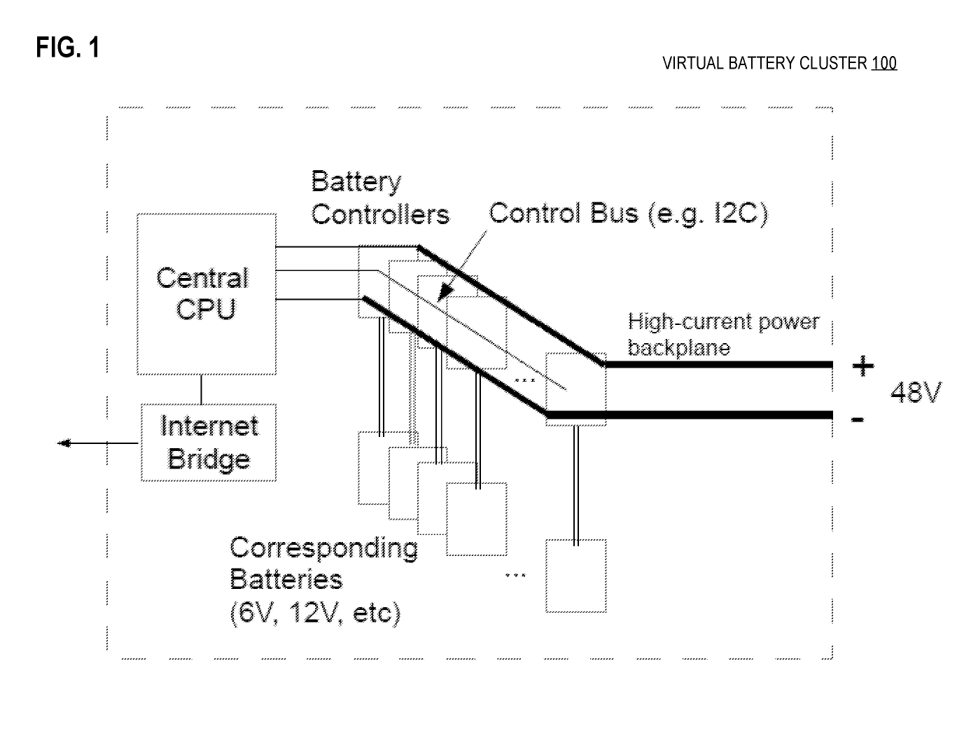

Referring to FIG. 1, the cluster controller can include one or more of the following components:
1. A common enclosure for arranging the batteries of the cluster
2. A common power bus (e.g., conductors) capable of handling the aggregate amperage of the cluster
3. A battery controller for each battery that can be connected to the cluster
4. A central CPU unit that acts as a coordinator for all the battery controllers and a point of communication to other clusters and to users via an internet connection

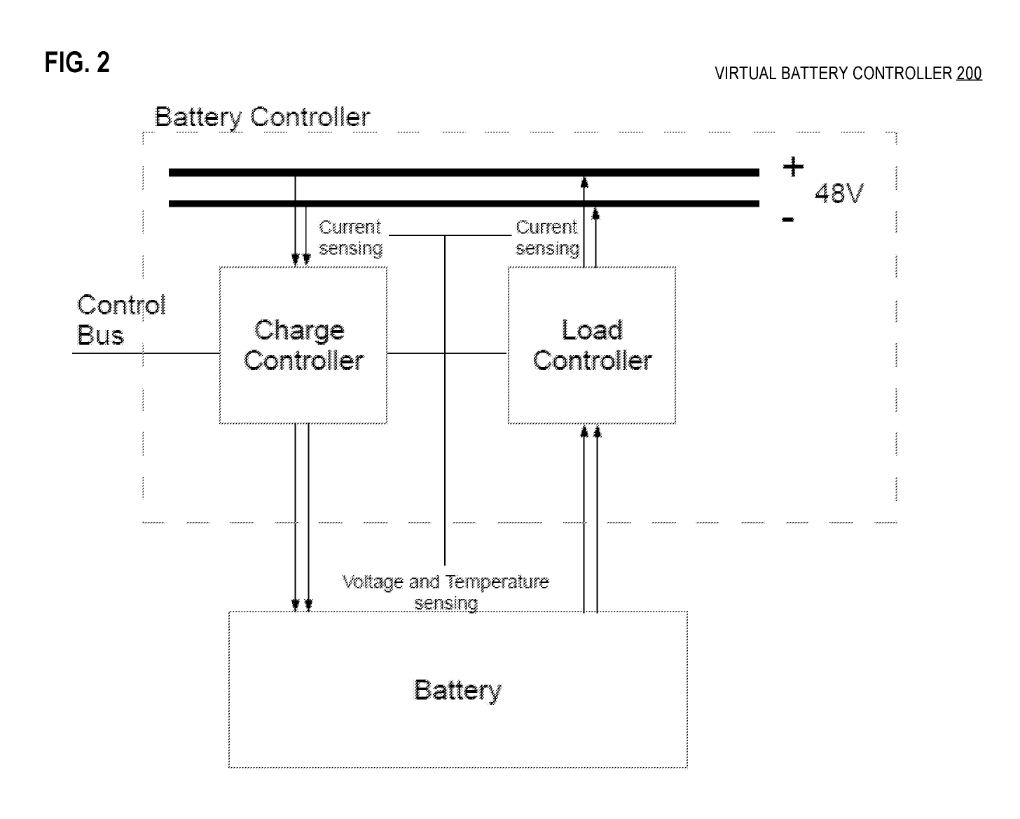

Referring to FIG. 2, each battery controller can include one or more of the following components:
1. A battery charge circuit that feeds power from the common bus to the assigned battery in a manner appropriate for the assigned battery's type. For example, charging the assigned battery can involve a Pulse-width modulation algorithm that feeds power from a 48v bus to a 12v battery using a fixed algorithm or it can involve a more complex DC/DC converter using a dynamic algorithm controlled by the central microprocessor based on historic information about the assigned battery.
2. A battery load control circuit that feeds power from the battery back to the common bus. For example, discharging from a particular battery can involve a MOSFET switch if the particular battery is of a same or higher voltage as the bus, or it can involve a more complex DC/DC converter under the control of the central microprocessor.
3. Additionally, the battery controller can include a current, voltage, and/or temperature sense subsystem to closely monitor the charge and load performance of the battery. This data is typically communicated on the control bus back to the central CPU, which can constantly update the settings of the charge and load control circuits.

Battery Control Program

A battery control program can be implemented in the central CPU to cause performance of the charge and load control of the various batteries in the cluster. The battery control program can cause performance of one or more functions of the following list of functions:
1. Control of which specific batteries are charged from the backplane (when power is supplied externally from a battery charger) and with how much current.
2. Control of which batteries are supplying current back to loads via the backplane and with how much current.
3. Collection of statistical data on the charge/discharge performance of each battery as well as the aggregate load/charge pattern of the virtual battery as a whole. This information can be used to optimize performance as described below.

Since each battery (or energy storage unit) is completely independently controlled, any number of optimizations can be performed. Examples include one or more of the following:
1. When in a net charging scenario, rather than spreading the charge proportionately across all batteries as in a traditional battery bank, the program can determine a more optimal strategy. For example, some batteries, due to degradation of their chemistry, will have a diminished ability to hold their charges and will return a low percentage of the stored energy. As described above in function 3, the program can detect this by monitoring batteries over time and can accordingly apply the available charge current first to the most efficient batteries, and only when those are charged, move to less efficient batteries.
2. Another aspect of charge management is that some battery types have different efficiencies based on the level of charge. In other words, some types are more efficient in keeping their charge when kept at a lower total charge versus other types. The program can also take this into account when deciding how to distribute the charge.
3. When in a net discharge scenario, the program can similarly determine the optimal batteries to discharge first. For example, some batteries may have a high self-discharge over time. Thus, it will be more efficient to discharge these into the loads first (since they will lose that energy anyway) and discharge more efficient batteries at a later time.
4. The program can also make important decisions to optimize the long term health (e.g., operational lifespan) of the cluster as a whole—regardless of whether it is in a net charge or net load scenario. For example, some batteries may become damaged if discharged below a certain level, which could happen by self-discharge if not charged for a long time. In this case, the program can use healthier batteries (e.g., energy storage units that are estimated to have longer operational lifespans) to keep a trickle charge on less healthy batteries across the cluster—even if net current in/out of the virtual battery is zero.
5. Some batteries may require frequent use to retain their capacity or may even have their capacity improved by exercise. The program can address this by proactively moving charge between batteries to exercise these types of batteries. Even if some stored energy is lost, the overall capacity of the cluster is improved in the long term.
6. Another aspect is the ability of the program to early detect batteries with potential problems, such as batteries that need to be reloaded with water (flooded). By removing these in a timely manner from the active charge/discharge duty in the cluster, these batteries can be serviced to prolong their operational lifespans. Removal can be performed even as the virtual battery is still functioning albeit at a lower total capacity.

Network Communication

The CPU can communicate with processors in other clusters and/or devices via a network connection. In some example embodiments, the network connection can include an Internet bridge. For example, a network connection can be established between the CPU and a web-based application that allows users to monitor, configure, and control the cluster(s) from any location on the Internet via a web browser. This application can also be configured to send alerts by email, text message, or phone call to users who can, for example, use the information to replace individual batteries or perform maintenance functions such as adding water to flooded batteries. The network connection can also be used to retrieve updated information about the most optimal algorithms for the program in the central CPU for various batteries such that the “intelligence” of the virtual battery continues to grow. The updated information could include or be based on statistical information gathered from other virtual batteries connected to the same central Internet software (e.g., the web-based application) such that this software becomes a global virtual battery intelligence system.

Heterogeneous Energy Storage Types

Typically, energy storage types must be homogeneous (e.g., of a similar or same type) in order to operate as a group of energy storage units. For example, rechargeable batteries typically have to be of a similar type to be combined into a battery bank.

The present disclosure enables heterogeneous energy storage types to operate as a group and provides one or more of the following benefits:
1. Each energy storage unit (e.g., battery) is treated optimally with regard to change and sourcing.
2. No assumptions about similarity are made. Any energy storage unit can be attached to a cluster and contribute to a total virtual capacity of the cluster.
3. Energy storage units removed from use in traditional clusters/banks can be re-used in a virtual cluster even if their capacity is diminished or they are otherwise unsuitable for a traditional cluster/bank.
4. Each energy storage unit in a cluster of energy storage units can be removed for service or replaced with another energy storage unit at any time without taking the cluster offline. In other words, the only effect to the cluster may be a corresponding reduction in the cluster's capacity.
5. Full lifetime values of energy storage units are realized, since degrading energy storage units do not adversely affect performance of other energy storage units in a cluster.
6. Energy storage units can be charged by any available charger by configuring the virtual battery to match charger settings and capabilities.

The present disclosure has potentially large societal benefits by enabling used energy storage units to be put back into service even after they have been discarded from traditional systems.

### 11.0 Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

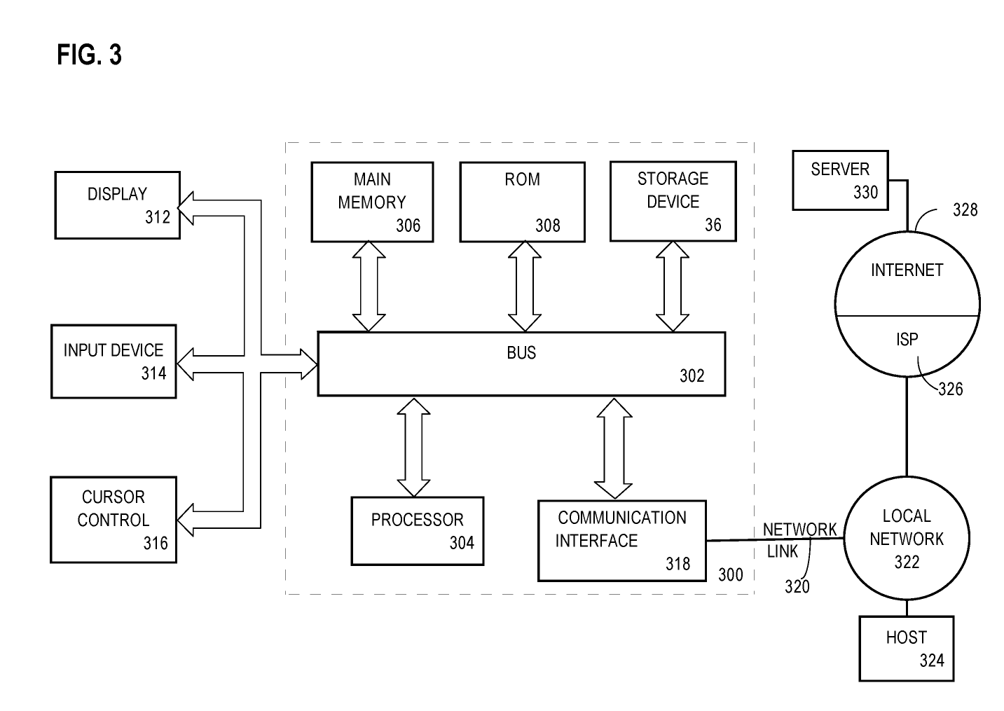

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 36, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 36. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 36. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 36 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 36, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A virtual battery system comprising:
a cluster of energy storage units;
a plurality of controllers, each controller being configured to monitor and control a respective energy storage unit in the cluster of energy storage units;
storage media;
one or more processors; and
one or more programs stored in the storage media and configured for execution by the one or more processors, the one or more programs comprising instructions for:
collecting, from the plurality of controllers, performance data for each energy storage unit in the cluster of energy storage units;
based on the performance data, individually adjusting a charging or a discharging of one or more energy storage units in the cluster of energy storage units.

2. The virtual battery system of claim 1, wherein the cluster of energy storage units comprise heterogeneous energy storage types.

3. The virtual battery system of claim 1, wherein the cluster of energy storage units comprises a hierarchy of sub-clusters of energy storage units.

4. The virtual battery system of claim 1, wherein the cluster of energy storage units comprise electrical energy storage units that do not have a same voltage capacity.

5. The virtual battery system of claim 1, wherein the cluster of energy storage units comprise energy storage units that do not have a same energy capacity.

6. The virtual battery system of claim 1, wherein the cluster of energy storage units comprise chemical energy storage units that do not have a same chemical.

7. The virtual battery system of claim 1, wherein:
the one or more programs are further configured to automatically detect a characteristic of at least one of the energy storage units in the cluster of energy storage units;
the characteristic comprises at least one of: an energy storage type, a voltage capacity, or an energy capacity.

8. The virtual battery system of claim 1, wherein individually adjusting a charging or a discharging of one or more energy storage units comprises selecting, based on the performance data, a particular energy storage unit from multiple nominally identical energy storage units in the cluster of energy storage units.

9. The virtual battery system of claim 1, wherein individually adjusting a charging or a discharging of one or more energy storage units comprises selecting, based on energy storage types of the energy storage units in the cluster of energy storage units, a particular energy storage unit of the cluster of energy storage units.

10. The virtual battery system of claim 1, wherein individually adjusting a charging or a discharging of one or more energy storage units comprises discharging one energy storage unit of the cluster of energy storage units to trickle charge a chemical energy storage unit of the cluster of energy storage units.

11. A method comprising:
at one or more virtual battery systems comprising one or more processors and storage media storing one or more programs executed by the one or more processors to perform the method, performing operations comprising:
collecting, from a plurality of controllers, performance data for each energy storage unit in a cluster of energy storage units, each controller in the plurality of controllers being configured to monitor and control a respective energy storage unit in the cluster of energy storage units;
based on the performance data, individually adjusting a charging or a discharging of one or more energy storage units in the cluster of energy storage units.

12. The method of claim 11, wherein the cluster of energy storage units comprise heterogeneous energy storage types.

13. The method of claim 11, wherein the cluster of energy storage units comprises a hierarchy of sub-clusters of energy storage units.

14. The method of claim 11, wherein the cluster of energy storage units comprise electrical energy storage units that do not have a same voltage capacity.

15. The method of claim 11, wherein the cluster of energy storage units comprise energy storage units that do not have a same energy capacity.

16. The method of claim 11, wherein the cluster of energy storage units comprise chemical energy storage units that do not have a same chemical.

17. The method of claim 11, wherein:
the one or more programs are further configured to automatically detect a characteristic of at least one of the energy storage units in the cluster of energy storage units;
the characteristic comprises at least one of: an energy storage type, a voltage capacity, or an energy capacity.

18. The method of claim 11, wherein individually adjusting a charging or a discharging of one or more energy storage units comprises selecting, based on the performance data, a particular energy storage unit from multiple nominally identical energy storage units in the cluster of energy storage units.

19. The method of claim 11, wherein individually adjusting a charging or a discharging of one or more energy storage units comprises selecting, based on energy storage types of the energy storage units in the cluster of energy storage units, a particular energy storage unit of the cluster of energy storage units.

20. The method of claim 11, wherein individually adjusting a charging or a discharging of one or more energy storage units comprises discharging one energy storage unit of the cluster of energy storage units to trickle charge a chemical energy storage unit of the cluster of energy storage units.
